(19) United States
(12) Patent Application Publication
(10) Pub. No.: US 2021/0182284 A1
(43) Pub. Date: Jun. 17, 2021

(54) SYSTEM AND METHOD FOR DATA INGESTION AND WORKFLOW GENERATION

(71) Applicant: BCE Inc., Montreal (CA)

(72) Inventors: Aws Aied Khalaf ALSAMARRIE, Toronto (CA); Viacheslav KRIUCHKOV, Notre-Dame-de-l'Île-Perrot (CA); Kun LIU, Scarborough (CA); Ruixiang XU, Toronto (CA); Agata ROJ, Mississauga (CA); Vaibhav SHARMA, Brampton (CA); Stephane VELLET, Sainte-Julienne (CA); Dragana VULPIC-BORK, Newmarket (CA); Harshavardhan GADGIL, Toronto (CA); Eric BEAUDET, Montreal (CA); Patrizia MARRO, Laval (CA); Daniel Darryl GODIN, Mississauga (CA); George ISKENDERIAN, Toronto (CA)

(21) Appl. No.: 17/122,422

(22) Filed: Dec. 15, 2020

Related U.S. Application Data
(60) Provisional application No. 62/948,417, filed on Dec. 16, 2019.

(51) Int. Cl. G06F 16/242; G06F 16/23

(52) U.S. Cl. CPC G06F 16/2433; G06F 16/2379

(57) ABSTRACT

A system and method are provided for coordinating data ingestion and workflow. In an implementation, the method includes: obtaining, at a processor, a plurality of data ingestion jobs; identifying, based on a stored batching factor, a subset of the plurality of data ingestion jobs to be grouped together; performing batch processing of the subset of data ingestion jobs together in a single shell action; and creating a workflow schedule based on the single shell action comprising the batched data ingestion jobs. The present disclosure advantageously provides batch processing of data ingestion jobs themselves, in contrast to existing approaches which may use data ingestion jobs to perform batch processing on underlying data. The data ingestion jobs can be Sqoop jobs, or in other formats or using other approaches such as through Kafka, Flume or Spark.

### CROSS REFERENCE TO RELATED APPLICATIONS

This application claims the benefit of priority of U.S. Provisional Patent Application No. 62/948,417 filed Dec. 16, 2019, which is incorporated herein by reference in its entirety. The present disclosure is related to co-pending patent application entitled “SYSTEM AND METHOD FOR MANAGING DATA OBJECT CREATION” filed of even date herewith, which is incorporated herein by reference.

### FIELD

The present disclosure relates to computer and network systems and methods, including but not limited to systems and methods for data ingestion and workflow generation.

### BACKGROUND

Computer and network systems, including “big data” environments, require data to be transferred from a source to a destination.

In a Hadoop environment or framework, Sqoop (Structured Query Language, or SQL, to Hadoop) is an example of a tool that provides automation for transferring data. For example, Sqoop can be used to ingest or import data from an external data source into Hadoop Distributed File System (HDFS). Commands are typically entered through a command line and associated with a map task to retrieve data from an external database.

After bringing data in, for example via Sqoop, in order to run on a cluster, a scheduler tool such as Oozie is typically used to coordinate and schedule running the Sqoop jobs on the cluster.

In implementations having a large number of data sources, it becomes impractical to manually code the Sqoop jobs with the required identifying information, password or other credentials, and to manually generate Oozie scheduling for each different environment or cluster.

Improvements in computer and network systems are desirable.

### BRIEF DESCRIPTION OF THE DRAWINGS

Embodiments of the present disclosure will now be described, by way of example only, with reference to the attached Figures.

FIG. 1 is a flowchart illustrating a method of coordinating data ingestion and workflow according to an embodiment of the present disclosure.

FIG. 2 is a block diagram illustrating a network environment including an apparatus for managing coordination of data ingestion and workflow according to an embodiment of the present disclosure.

FIG. 3 is a block diagram illustrating an apparatus for managing coordination of data ingestion and workflow according to an embodiment of the present disclosure.

FIG. 4 is a block diagram illustrating an apparatus for managing coordination of data ingestion and workflow according to another embodiment of the present disclosure.

### DETAILED DESCRIPTION

A system and method are provided for coordinating data ingestion and workflow. In an implementation, the method includes: obtaining, at a processor, a plurality of data ingestion jobs; identifying, based on a stored batching factor, a subset of the plurality of data ingestion jobs to be grouped together; performing batch processing of the subset of data ingestion jobs together in a single shell action; and creating a workflow schedule based on the single shell action comprising the batched data ingestion jobs. Embodiments of the present disclosure advantageously provides batch processing of data ingestion jobs themselves, in contrast to existing approaches which may use data ingestion jobs to perform batch processing on underlying data. The data ingestion jobs can be Sqoop jobs, or in other formats or using other approaches such as through Kafka, Flume or Spark.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

In an embodiment, the present disclosure provides a computer-implemented method of coordinating data ingestion and workflow. The method comprises: obtaining, at a processor, a plurality of data ingestion jobs; identifying, based on a stored batching factor, a subset of the plurality of data ingestion jobs to be grouped together; performing batch processing of the subset of data ingestion jobs together in a single shell action; and initiating creation of a workflow schedule based on the single shell action comprising the batched data ingestion jobs.

In an example embodiment, the plurality of data ingestion jobs comprises a plurality of Sqoop (Structured Query Language to Hadoop) jobs.

In an example embodiment, the plurality of Sqoop jobs are associated with a plurality of data sources of the same type.

In an example embodiment, the plurality of Sqoop jobs are associated with a plurality of data sources, the plurality of data sources having a first data source type and a second data source type.

In an example embodiment, the plurality of Sqoop jobs are associated with a plurality of data sources, the plurality of data sources having a plurality of data source types.

In an example embodiment, the plurality of Sqoop jobs are obtained based on property data.

In an example embodiment, the property data is provided in a property file.

In an example embodiment, the stored batching factor is provided in the property data.

In an example embodiment, the stored batching factor is determined based on one or more of: available resources; available bandwidth; or another constraint on the source.

In an example embodiment, the stored batching factor is obtained based on one or more of: available resources; available bandwidth; or another constraint on the source.

In an example embodiment, obtaining the plurality of data ingestion jobs comprises generating code associated with the data ingestion jobs, wherein the generated code enables obtaining and running the data ingestion jobs.

In an example embodiment, obtaining the plurality of data ingestion jobs comprises generating data ingestion job code that comprises the data ingestion jobs.

In an example embodiment, performing batch processing of the subset of data ingestion jobs together in the single shell action comprises ingesting a plurality of source tables in a single workflow.

In an example embodiment, performing batch processing of the subset of data ingestion jobs together in the single shell action comprises capturing a schema for an ingestion source table such that the workflow is unaffected by source table schema changes.

In an example embodiment, performing batch processing of the subset of data ingestion jobs together in the single shell action comprises capturing a schema for a table each time on ingestion and updating the schema in the workflow each time the workflow is running.

In an example embodiment, initiating creation of the workflow schedule comprises creating the workflow based on the single shell action comprising the batched data ingestion jobs.

In an example embodiment, initiating creation of the workflow schedule comprises creating an Oozie workflow based on the single shell action comprising the batched Sqoop jobs.

In another embodiment, the present disclosure provides an apparatus for coordinating data ingestion and workflow. The apparatus comprises at least one processor, and a memory storing instructions that, when executed by the at least one processor, cause the apparatus to perform the method according to any of the embodiments described and illustrated herein.

In a further embodiment, the present disclosure provides a system for managing creation of a data object. The system comprises an apparatus configured to perform the method according to any of the embodiments described and illustrated herein, and a computer-readable medium storing the property data.

In another embodiment, the present disclosure provides a system for managing creation of a data object. The system comprises: an apparatus configured to perform the method according to any of the embodiments described and illustrated herein; and a continuous integration/continuous deployment (Cl/CD) call generator configured to generate and send Cl/CD calls to different clusters.

In a further embodiment, the present disclosure provides a computer-readable medium storing instructions that, when executed, cause performance of the method according to any of the embodiments described and illustrated herein.

In another embodiment, the present disclosure provides an apparatus for managing coordination of data ingestion and workflow. The apparatus comprises: a data ingestion job receiver configured to obtain, at a processor, a plurality of data ingestion jobs; a batch identifier configured to identify, based on a stored batching factor, a subset of the plurality of data ingestion jobs to be grouped together; a batch processor configured to perform batch processing of the subset of data ingestion jobs together in a single shell action; and a workflow schedule initiator configured to initiate creation of a workflow schedule based on the single shell action comprising the batched data ingestion jobs.

To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

In known approaches, code is generated per table, for only one Sqoop operation and for only one source, to push it into Hadoop. According to an embodiment of the present disclosure, a plurality of Sqoop jobs are batched together and processed in the same shell action, and in the same Oozie workflow. A method according to an example embodiment of the present disclosure is implemented based on code generated to perform the actions.

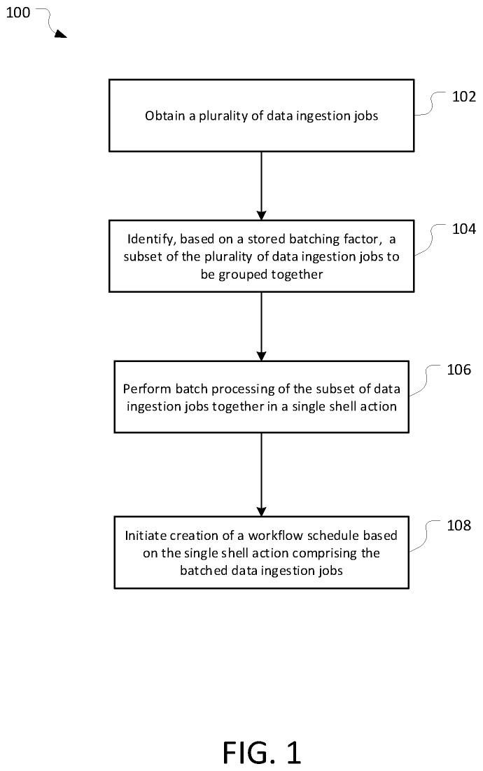

FIG. 1 is a flowchart illustrating a method 100 for coordinating data ingestion and workflow according to an embodiment of the present disclosure. The operations of method presented below are intended to be illustrative. In some embodiments, method may be accomplished with one or more additional operations not described, and/or without one or more of the operations discussed. Additionally, the order in which the operations of method are illustrated and described below is not intended to be limiting.

In some embodiments, method may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method in response to instructions stored electronically on an electronic storage medium. The one or more processing devices may include one or more devices configured through hardware, firmware, and/or software to be specifically designed for execution of one or more of the operations of method.

At 102, a plurality of data ingestion jobs are obtained. In an example embodiment, step 102 further comprises generating code associated with the data ingestion jobs, wherein obtaining the data ingestion jobs is enabled using the generated code. In an example embodiment, step 102 comprises generating data ingestion job code that comprises the data ingestion jobs. In an example embodiment, the plurality of data ingestion jobs are obtained through code generation. In an example embodiment, the data ingestion jobs comprise Sqoop jobs. In an example embodiment, the plurality of Sqoop jobs are associated with a plurality of data sources of the same type. In an example embodiment, data from only one source is batched together, so that the whole workflow does not fail if information is missing for only one of the batched tasks.

In another example embodiment, the plurality of Sqoop jobs are associated with a plurality of data sources, the plurality of data sources having a first data source type and a second data source type. In a further example embodiment, the plurality of Sqoop jobs are associated with a plurality of data sources, the plurality of data sources having a plurality of data source types. In an implementation, each source type has a different mapping to convert to Hadoop. Embodiments of the present disclosure ensure proper mapping of each source type to Hadoop, for example MySQL server, Oracle, etc.

At 104, a subset of the plurality of data ingestion jobs is identified to be grouped together. The grouping is based on a stored batching factor. In an embodiment, the present disclosure provides or performs batching of a plurality of Sqoop jobs. In an example embodiment, a plurality of Sqoop jobs is batched per shell action. In an example embodiment, two (2) Sqoop jobs are batched per shell action, or two Sqoop operations per action. In another example embodiment, a different number of a plurality of Sqoop jobs is batched per shell action.

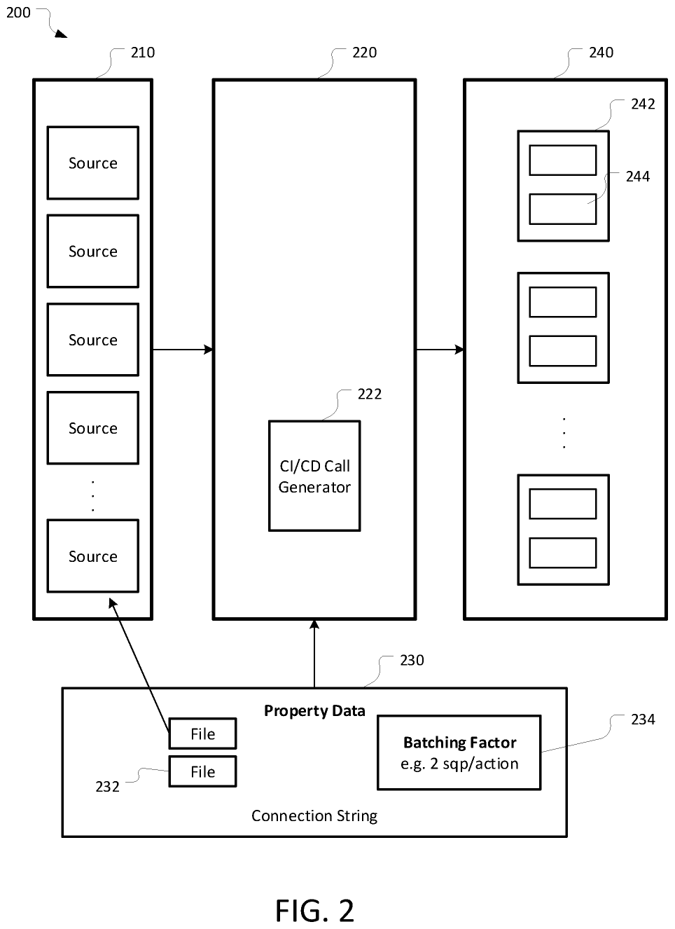

In an example embodiment, the number of Sqoop jobs per action is defined in the stored batching factor, which can be stored in a machine-readable memory, as shown at 234 in FIG. 2. In an embodiment, the stored batching factor is obtained based on one or more of: available resources; available bandwidth; or other constraints on the source. In another embodiment, the stored batching factor is determined based on one or more of: available resources; available bandwidth; or other constraints on the source. For example, some sources will not permit more than one query per day. The number of Sqoop jobs batched per shell action can be varied based on the parameters of a given use case.

In an example embodiment, the stored batching factor is obtained based on user input. For example, the system can be configured to send an email to a user, asking “What is a good number of Sqoop jobs to batch together that I can use?” In response to the system receiving and parsing the user input, the number provided in the user input for that specific source is used, along with the list tables for that source, to generate the batching for that source.

Referring back to FIG. 1, at 106 the method performs batch processing of the subset of data ingestion jobs together in a single shell action. The batched Sqoop jobs processed together in a single shell action are then put in a workflow schedule, such as an Oozie workflow. Embodiments of the present disclosure advantageously provides batch processing of data ingestion jobs themselves, in contrast to existing approaches which may use data ingestion jobs to perform batch processing on underlying data. In an example embodiment, batch processing of data ingestion jobs comprises ingesting a plurality of tables in a single workflow, which simplifies the task compared to if one table is ingested in one workflow. Typically, if the source table to the schema changes, the workflow needs to be regenerated. According to an embodiment of the present disclosure, schema changes are integrated such that the method handles a schema change in the source table, without updating the workflow. According to an example implementation, the method comprises capturing a schema for an ingestion source table, such that the workflow is independent of, and unaffected by, source table changes. This is enabled in an example embodiment because the method captures the schema each time on ingestion, and updates the schema in the workflow every time it's running. This method of batch processing of data ingestion jobs is different from batch processing of data, since there is no schema associated with data, compared to a job that has an associated schema.

At 108, the method initiates creation of a workflow schedule based on the single shell action comprising the batched data ingestion jobs. In an example embodiment, an Oozie workflow, or another workflow, is generated including a plurality of actions, and in each action there will be, for example, two Sqoop operations, based on the batch processing. The total number of actions will be a factor of the number of tables per source. In an example embodiment, initiating creation of the workflow schedule comprises creating the workflow based on the single shell action comprising the batched data ingestion jobs. In another example embodiment, initiating creation of the workflow schedule comprises creating an Oozie workflow based on the single shell action comprising the batched Sqoop jobs.

In an embodiment, the plurality of Sqoop jobs are obtained based on property data, which can be used to represent information relating to the data sources. In an example embodiment, the property data is provided in a property file. In another example embodiment, the property data is obtained and entered via a web interface. In an example embodiment, the stored batching factor is provided in the property data.

FIG. 2 is a block diagram illustrating a network environment 200 including an apparatus 220 for managing coordination of data ingestion and workflow according to an embodiment of the present disclosure. The network environment includes a plurality of data sources 210. Property data 230, for example including or provided as a property file 232, is used to represent information relating to the data sources. As mentioned in relation to FIG. 1, at 104, a subset of the plurality of data ingestion jobs is identified to be grouped together. The grouping is based on a stored batching factor 234, for example as shown in FIG. 2.

In an example embodiment, the property data is provided to a method according to an embodiment, where the method is running on the pipeline. For example, the method running on the pipeline can invoke certain scripts, such as Python, Java, shell scripts or other code. In an example embodiment, the code resides on HDFS, or on the cluster.

The apparatus 200 further comprises a workflow scheduler 240. Referring back to FIG. 1, at 106 the method performs batch processing of the subset of data ingestion jobs together in a single shell action. The batched Sqoop jobs processed together in a single shell action are then put in a workflow schedule, for example at or using the workflow scheduler 240, such as an Oozie workflow. Referring back to FIG. 1, at 108, the method initiates, for example at or using the workflow scheduler 240, creation of a workflow schedule based on the single shell action 242 comprising the batched data ingestion jobs 244.

Consider an example implementation with 50 tables in a source. In an embodiment, the tables are in one property file, from one source. In another embodiment, a single code generation process handles multiple source types (e.g. Oracle, MySQL, SQL server), and batches those together.

Consider a plurality of sources having a plurality of tables to be provided to Hadoop. According to an embodiment of the present disclosure, property data 230, for example a property file 232 named PROPS, comprises a list of the source tables, including the source information. The number of source tables is simply counted. In an embodiment, the property data comprises the names of the tables. In an example embodiment, the source of the table is defined in a connection string, which is provided in the property data. In an example embodiment, property data comprises an identification of a plurality of sources as connection strings, and the names of the associated tables for each of the connection strings. Typically, there is one connection string, and different property files for each connection string. In another embodiment, a plurality of files are provided for each connection string. A single property file can comprise a plurality of files per connection string, and a list of key values.

According to known solutions, a user must manually modify each configuration of Sqoop job and Oozie workflow for each cluster (e.g. development, pre-production, production, etc.). Also, a user typically has to manually log in to separate clusters, and put a separate executable on each cluster.

Embodiments of the present disclosure provide a multi-cluster approach comprising a central set of steps that is agnostic of the cluster properties, and uses existing Cl/CD (continuous integration/continuous deployment or continuous development) solutions. According to an embodiment of the present disclosure, the system automatically customizes the configuration of the Sqoop job and Oozie workflow for each cluster, or in a way that is agnostic of the cluster properties. In an example embodiment, when a Cl/CD pipeline is running, an environment variable is provided to indicate which environment is running. In an embodiment, the environment variable is a property of the cluster configuration, which can then be read or obtained to know which one to use/load in this environment.

As shown in FIG. 2, the apparatus 220 comprises a Cl/CD call generator 222 to generate and provide Cl/CD calls to different clusters. In an example embodiment, the Cl/CD call generator 222 provides automatic invoking of Cl/CD, which allows the calls to run on multiple clusters with Cl/CD invoking. In an example embodiment, Cl/CD calls to different clusters are provided.

In an example embodiment, the code is how the data is called from the Cl/CD pipeline. For example, a Cl/CD pipeline is a set of steps that runs against something called a runner, or any kind of process, that basically implements those steps. For example, suppose a user tells the process to create a table; usually in software, traditionally binaries are deployed, usually manually by a plurality of sys admins. Examples of Cl/CD solutions include GitLab, Jenkins, and GitLab Cl.

In an embodiment, the present disclosure provides multi-batch processing on different clusters. For example, if a property file defines 1000 tables, embodiments of the present disclosure are configured to cause the running of, or to run, a single process of automatic code generation for all 1000 tables, rather than have a person individually enable each job.

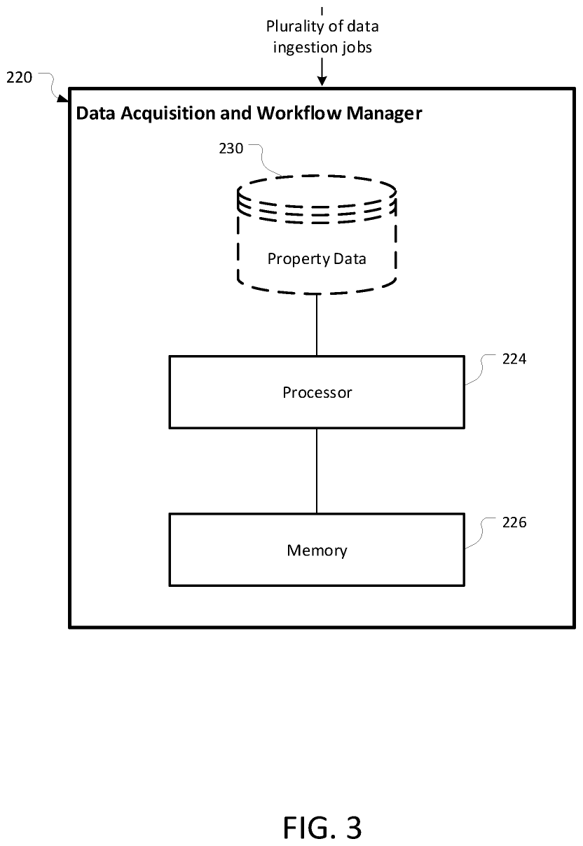

FIG. 3 is a block diagram illustrating an apparatus for managing coordination of data ingestion and workflow according to an embodiment of the present disclosure. As shown in FIG. 3, the apparatus 220 comprises at least one processor 210; and a memory 226 storing instructions that, when executed by the at least one processor, cause the apparatus to perform the method as described and illustrated according to embodiments described herein. The apparatus 220 can optionally store the property data 230 after receiving or obtaining the property data.

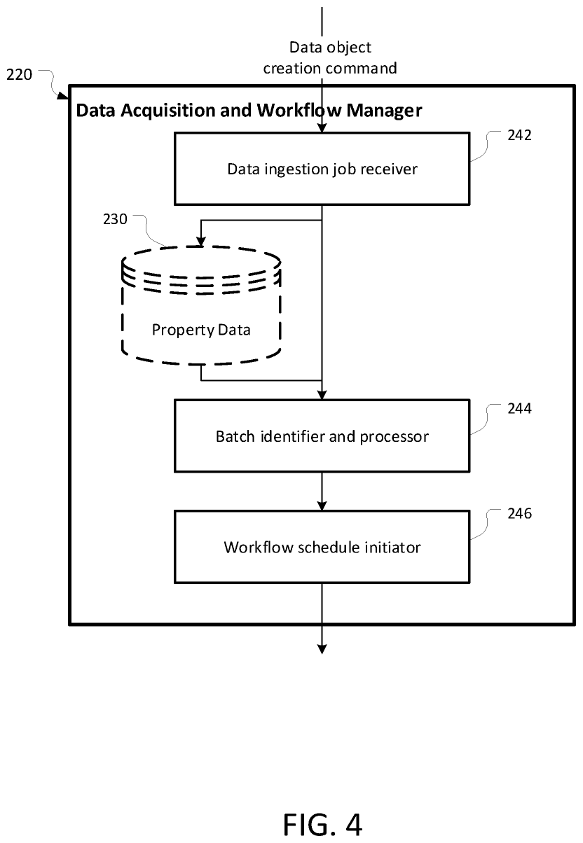

FIG. 4 is a block diagram illustrating an apparatus 220 for managing coordination of data ingestion and workflow according to another embodiment of the present disclosure. The apparatus 220 includes a data ingestion job receiver 242 configured to obtain, at a processor, a plurality of data ingestion jobs. A batch identifier and processor 244 is configured to: identify, based on a stored batching factor, a subset of the plurality of data ingestion jobs to be grouped together; and perform batch processing of the subset of data ingestion jobs together in a single shell action. In an alternative embodiment, a batch identifier is configured to identify, based on a stored batching factor, a subset of the plurality of data ingestion jobs to be grouped together, and a separate batch processor is configured to perform batch processing of the subset of data ingestion jobs together in a single shell action. A workflow schedule initiator 246 is configured to initiate creation of a workflow schedule based on the single shell action comprising the batched data ingestion jobs.

In an embodiment, the present disclosure provides a system for managing creation of a data object, the system comprising: an apparatus configured to perform the method according to an embodiment described or illustrated herein; and a computer-readable medium storing the property data.

In another embodiment, the present disclosure provides a system for managing creation of a data object, the system comprising: an apparatus configured to perform the method according to an embodiment described or illustrated herein; a continuous integration/continuous deployment (Cl/CD) call generator configured to generate and send Cl/CD calls to different clusters.

In a further embodiment, the present disclosure provides a computer-readable medium storing instructions that, when executed, cause performance of a method according to an embodiment described or illustrated herein.

Embodiments of the present disclosure provide a method and system for ingesting vast amounts of data. Such data ingestion is required, in some implementations, to build or refresh distributed business models and provide insights into business needs and benefits for network providers. As part of a daily routine, data engineers may need to keep an eye on data consistency in Network Hadoop and data sources, and be able to ingest new data within the same day. It is quite time-consuming and error-prone to do this manually, especially when working with large tables that have hundreds or even thousands of columns. According to an embodiment of the present disclosure, including code auto-generation, the entire process including deployment can be fully automated without human intervention.

Embodiments of the present disclosure provide an improvement to computer functionality. In contrast to known approaches, embodiments of the present disclosure improve the way the computer stores and retrieves data in memory in combination with a specific data structure of the property data, or property file. Embodiments of the present disclosure represent a specific implementation of a solution to a problem in the software arts, and are not simply the addition of general purpose computers added post-hoc to an abstract idea.

Embodiments of the present disclosure relate to generation of data ingestion workflows from relational databases in a way that is fully automated which leads to shorter software development cycle time, faster access to data, faster time to analytics. Embodiments of the present disclosure also relate to ingestion workflow failure auto-recovery.

A computer-implemented method of coordinating data ingestion and workflow, according to embodiments of the present disclosure, improve the functioning of a computer, or improve the computer capabilities, or both. Similarly, a computer-implemented method of managing creation of a data object, or managing coordination of data ingestion and workflow, improves the functioning of a computer, or improve the computer capabilities, or both. The same applies to an apparatus, system or computer-readable medium associated with the computer-implemented method according to embodiments of the present disclosure.

For example, by performing batch processing of a subset of data ingestion jobs together in a single shell action, the processing at the processor or computer is simplified, thereby providing an improvement in processing by using less processing power, or fewer instructions, or both, than known methods, while providing the same or better performance. Thus, a computer-implemented method according to an embodiment of the present disclosure, in combination with the processor or computer, solves a computer problem. Embodiments of the present disclosure manifest a discernible physical effect or change, for example based on the electronic, magnetic or optical changes that take place during the performance of the computer-implemented method according to embodiments of the present disclosure, and operation of a processor or computer. The computer-implemented method according to an embodiment of the present disclosure cooperates with other elements, such as a processor or a computer and in some embodiments a memory or computer-readable medium, so as to become part of a combination of elements that relate to the manual or productive arts and that has physical existence or manifests a discernible physical effect or change.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

In some embodiments of the present disclosure, a system may include one or more computing platforms. Computing platform(s) may be configured to communicate with one or more remote platforms according to a client/server architecture, a peer-to-peer architecture, and/or other architectures. Remote platform(s) may be configured to communicate with other remote platforms via computing platform(s) and/or according to a client/server architecture, a peer-to-peer architecture, and/or other architectures. Users may access system via remote platform(s).

Computing platform(s) may be configured by machine-readable instructions. Machine-readable instructions may include one or more instruction modules. The instruction modules may include computer program modules.

In some embodiments, computing platform(s), remote platform(s), and/or external resources may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s), remote platform(s), and/or external resources may be operatively linked via some other communication media.

A given remote platform may include one or more processors configured to execute computer program modules. The computer program modules may be configured to enable an expert or user associated with the given remote platform to interface with system and/or external resources, and/or provide other functionality attributed herein to remote platform(s). By way of non-limiting example, a given remote platform and/or a given computing platform may include one or more of a server, a desktop computer, a laptop computer, a handheld computer, a tablet computing platform, a NetBook, a Smartphone, a gaming console, and/or other computing platforms.

External resources may include sources of information outside of system, external entities participating with system, and/or other resources. In some embodiments, some or all of the functionality attributed herein to external resources may be provided by resources included in system.

Computing platform(s) may include electronic storage, one or more processors, and/or other components. Computing platform(s) may include communication lines, or ports to enable the exchange of information with a network and/or other computing platforms. Computing platform(s) may include a plurality of hardware, software, and/or firmware components operating together to provide the functionality attributed herein to computing platform(s). For example, computing platform(s) may be implemented by a cloud of computing platforms operating together as computing platform(s).

Electronic storage may comprise non-transitory storage media that electronically stores information. The electronic storage media of electronic storage may include one or both of system storage that is provided integrally (i.e., substantially non-removable) with computing platform(s) and/or removable storage that is removably connectable to computing platform(s) via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processor(s), information received from computing platform(s), information received from remote platform(s), and/or other information that enables computing platform(s) to function as described herein.

Processor(s) may be configured to provide information processing capabilities in computing platform(s). As such, processor(s) may include one or more of a digital processor, an analog processor, a digital circuit designed to process information, an analog circuit designed to process information, a state machine, and/or other mechanisms for electronically processing information. In some embodiments, processor(s) may include a plurality of processing units. These processing units may be physically located within the same device, or processor(s) may represent processing functionality of a plurality of devices operating in coordination. Processor(s) may be configured to execute modules or computer-implemented methods recited herein by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The above-described embodiments are intended to be examples only. Alterations, modifications and variations can be effected to the particular embodiments by those of skill in the art without departing from the scope, which is defined solely by the claims appended hereto.

What is claimed is:

1. A computer-implemented method of coordinating data ingestion and workflow comprising:
obtaining, at a processor, a plurality of data ingestion jobs;
identifying, based on a stored batching factor, a subset of the plurality of data ingestion jobs to be grouped together;
performing batch processing of the subset of data ingestion jobs together in a single shell action; and
initiating creation of a workflow schedule based on the single shell action comprising the batched data ingestion jobs.

2. The computer-implemented method of claim 1, wherein the plurality of data ingestion jobs comprises a plurality of Sqoop (Structured Query Language to Hadoop) jobs.

3. The computer-implemented method of claim 2, wherein the plurality of Sqoop jobs are associated with a plurality of data sources of the same type.

4. The computer-implemented method of claim 2, wherein the plurality of Sqoop jobs are associated with a plurality of data sources, the plurality of data sources having a first data source type and a second data source type.

5. The computer-implemented method of claim 2, wherein the plurality of Sqoop jobs are associated with a plurality of data sources, the plurality of data sources having a plurality of data source types.

6. The computer-implemented method of claim 2, wherein the plurality of Sqoop jobs are obtained based on property data.

7. The computer-implemented method of claim 6, wherein the property data is provided in a property file.

8. The computer-implemented method of claim 6, wherein the stored batching factor is provided in the property data.

9. The computer-implemented method of claim 8, wherein the stored batching factor is determined based on one or more of: available resources; available bandwidth; or another constraint on the source.

10. The computer-implemented method of claim 8, wherein the stored batching factor is obtained based on one or more of: available resources; available bandwidth; or another constraint on the source.

11. The computer-implemented method of claim 1, wherein obtaining the plurality of data ingestion jobs comprises generating code associated with the data ingestion jobs, wherein the generated code enables obtaining and running the data ingestion jobs.

12. The computer-implemented method of claim 1, wherein obtaining the plurality of data ingestion jobs comprises generating data ingestion job code that comprises the data ingestion jobs.

13. The computer-implemented method of claim 1, wherein performing batch processing of the subset of data ingestion jobs together in the single shell action comprises ingesting a plurality of source tables in a single workflow.

14. The computer-implemented method of claim 1, wherein performing batch processing of the subset of data ingestion jobs together in the single shell action comprises capturing a schema for an ingestion source table such that the workflow is unaffected by source table schema changes.

15. The computer-implemented method of claim 1, wherein performing batch processing of the subset of data ingestion jobs together in the single shell action comprises capturing a schema for a table each time on ingestion and updating the schema in the workflow each time the workflow is running.

16. The computer-implemented method of claim 1, wherein initiating creation of the workflow schedule comprises creating the workflow based on the single shell action comprising the batched data ingestion jobs.

17. The computer-implemented method of claim 2, wherein initiating creation of the workflow schedule comprises creating an Oozie workflow based on the single shell action comprising the batched Sqoop jobs.

18. An apparatus for coordinating data ingestion and workflow, the apparatus comprising:
at least one processor; and
a memory storing instructions that, when executed by the at least one processor, cause the apparatus to perform a computer-implemented method of coordinating data ingestion and workflow comprising:
obtaining, at a processor, a plurality of data ingestion jobs;
identifying, based on a stored batching factor, a subset of the plurality of data ingestion jobs to be grouped together;
performing batch processing of the subset of data ingestion jobs together in a single shell action; and
initiating creation of a workflow schedule based on the single shell action comprising the batched data ingestion jobs.

21. A computer-readable medium storing instructions that, when executed, cause performance of a computer-implemented method of coordinating data ingestion and workflow comprising:
obtaining, at a processor, a plurality of data ingestion jobs;
identifying, based on a stored batching factor, a subset of the plurality of data ingestion jobs to be grouped together;
performing batch processing of the subset of data ingestion jobs together in a single shell action; and
initiating creation of a workflow schedule based on the single shell action comprising the batched data ingestion jobs.

22. An apparatus for managing coordination of data ingestion and workflow, the apparatus comprising:
a data ingestion job receiver configured to obtain, at a processor, a plurality of data ingestion jobs;
a batch identifier configured to identify, based on a stored batching factor, a subset of the plurality of data ingestion jobs to be grouped together;
a batch processor configured to perform batch processing of the subset of data ingestion jobs together in a single shell action; and
a workflow schedule initiator configured to initiate creation of a workflow schedule based on the single shell action comprising the batched data ingestion jobs.
